(19) United States
(12) Patent Application Publication
(10) Pub. No.: US 2006/0249324 A1
(43) Pub. Date: Nov. 9, 2006

(54) Method and system for protecting a passenger of a vehicle

(76) Inventors: Dirk Weber, Stuttgart (DE); Alfred Kuttenberger, Moeglingen (DE)

Correspondence Address: KENYON & KENYON LLP, ONE BROADWAY, NEW YORK, NY, 10004, US

(21) Appl. No.: 10/507,443

(22) PCT Filed: Nov. 19, 2002
(86) PCT No.: PCT/DE02/04254

§ 371 Date: Apr. 18, 2006

(30) Foreign Application Priority Data
Mar. 13, 2002 (DE) 102 10 928.1

(51) Int. Cl. B60K 28/00; B60R 21/00; B60R 22/00

(52) U.S. Cl. 180/268; 180/271; 280/801.1; 280/806

(57) ABSTRACT

A method for protecting a vehicle passenger is provided, in which method the occurrence of a sharp pressure loss in a tire, as it occurs in particular in the case of a tire blowout, is detected and is used for activating a reversible system assigned to a seat, in particular to a belt tensioner, so as to fix the occupant in the seat in this potentially dangerous situation. The detection of this rapid loss can moreover be used for adjusting the triggering thresholds of other, reversible and irreversible, restraint devices.

### FIELD OF THE INVENTION

The present invention relates to a method and a setup for protecting a vehicle occupant in the occurrence of a potentially dangerous situation, in which in the detection of the situation at least one system can be triggered that is at least capable of being activated in a reversible manner and that is assigned to the seat of the vehicle occupant.

### BACKGROUND INFORMATION

In vehicles of the luxury class it is known that, in the detection of an accident such as a crash into an obstacle, reversible and/or irreversible restraint devices such as a belt tensioner or an airbag may be triggered to protect the vehicle occupant at least against serious injuries. It is further known in the art that by evaluating detected signals such as distance signals and rating them it is possible to obtain a prediction as to whether an immediately imminent accident is to be expected with high probability and, if indicated, to activate reversible systems which bring the vehicle occupant into a position that is especially advantageous for avoiding injuries in the event of an actual accident. One of these systems is a belt tensioner by which the vehicle occupant in such a potentially dangerous situation is fixed in his seat so that the occupant in a subsequent accident is in a better position for triggering an airbag (cf., e.g., published German patent document DE 44 11 184).

A dangerous situation, in which the known procedures fail or intervene too late, however, is the occurrence of a tire blowout. A tire blowout may result in the vehicle skidding, which can lead to a dangerous accident. Even if the vehicle driver is able to catch the vehicle in case of a tire blowout, it is possible that, due to pendulum movements of the upper body caused by the skidding, a passenger will hit his head against the window or the like since a passenger is normally significantly less attentive than the vehicle driver. If the skidding of the vehicle results in an accident, the reversible and/or irreversible systems can be activated only on the basis of the evaluations that are normally used to activate them.

### SUMMARY

It is an objective of the present invention to provide a method and a setup (or system) by which a vehicle occupant can be protected even in the event of such an unexpected and potentially dangerous situation such as a tire blowout or a rapid loss of tire pressure.

For this purpose, the present invention utilizes the fact that, at least in vehicles of the luxury class, the tire pressure can be monitored, to which end a pressure sensor is assigned to each tire and a signal corresponding to the actual pressure of the tire is displayed to the vehicle driver.

The present invention utilizes the fact that this display signal regarding the actual tire pressure can be processed further to obtain information about a rapid loss of tire pressure in one of the tires, as it caused by a tire blowout, whereupon this information in turn can be processed further to trigger, e.g., reversible belt tensioners to fixate the occupant(s) in this potentially dangerous situation in the respective seat so as to reduce pendulum movements of the upper body in case the vehicle starts to skid as a result of a tire blowout. The occupant is thereby prevented from hitting his head against the window. Furthermore, the occupant will be in a better position for triggering an airbag if the skidding results in an accident. In a similar way, it is of course also possible that in detecting the tire blowout the sitting position of the affected occupant is brought into the optimum position for triggering an airbag, for example by adjusting the seat back and/or the headrest and the like.

The detection of the occurrence of a tire blowout can thus also be used as one of the signals by which the at least one triggering threshold of the reversible and/or irreversible restraint systems can be adapted to the particular given situation with the aid of other signals detecting an actual situation.

### BRIEF DESCRIPTION OF THE DRAWING

FIG. 1 shows the application of an example embodiment of the present invention in a belt tensioning system.

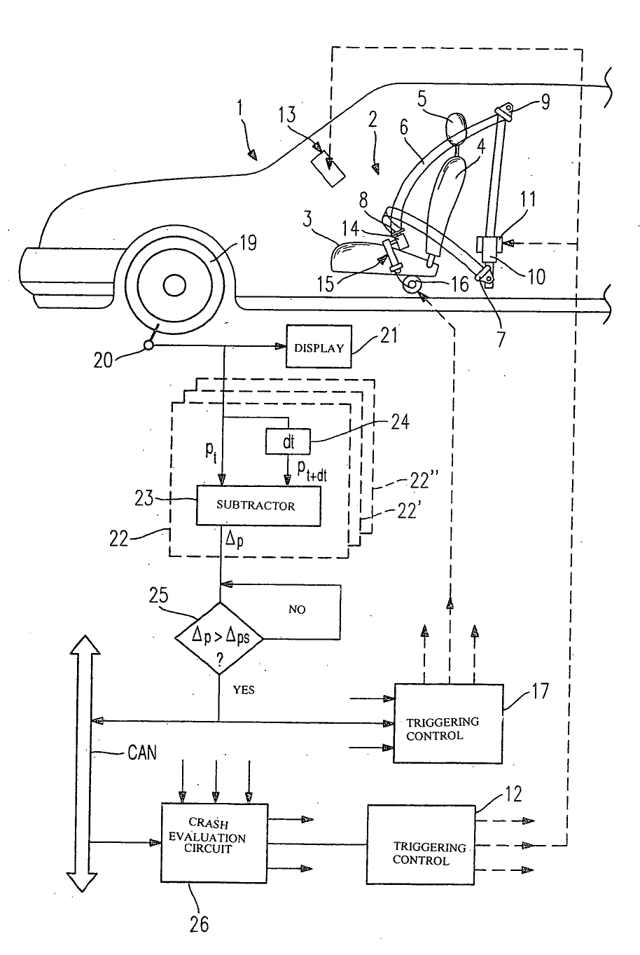

### DETAILED DESCRIPTION

In a vehicle 1, a restraint belt 6 is assigned to seat 2 having a seat surface 3, a seat back 4 and a headrest 5. One end 7 of belt 6 is fixed to the body of vehicle 1, for example to a pillar of the chassis (anchor plate). In a section, belt 6, laid around the vehicle occupant (not shown), can be fastened using a belt tongue 8. Belt 6 is further run via a redirecting element 9 on vehicle 1 to a belt tensioner 10, to which an activatable electric motor or an activatable firing device 11 is assigned for tightening belt 6. Firing device 11 is triggered by a triggering control device 12, which then triggers belt tensioner 10 to wind up belt 6 if an accident (crash) is detected, as explained further below.

An irreversible system, i.e., a triggerable airbag 13, is assigned to seat 2, which is likewise activatable, i.e., ignitable, by triggering control 12 if an accident is detected.

Further triggerable restraint systems such as a side airbag and the like (not shown) can be assigned to seat 2 and thus to the vehicle occupant.

In the exemplary embodiment, a tensioning mechanism 15, which is (reversibly) activatable by an electric motor 16, is assigned to belt tongue 8, i.e., to the receiving part or belt buckle 14 assigned to seat 2. The activation is initiated by a triggering control 17 if on the basis of an evaluation of parameters the high probability that an accident will occur has been detected. In the activation, electric motor 16 brings belt buckle 14 and hence belt tongue 8 into a position, in which belt 6 brings the vehicle occupant into a precautionary, fixed position, so that, in case of an accident, belt tensioner 10 is able to bring belt 6 rapidly into a position that is even better for protecting the vehicle occupant. This so-called precrash procedure can also be applied to other systems, by which a vehicle occupant can be brought into a more favorable position in the case of an accident (case of a crash), for example by adjusting seat back 4 and/or by adjusting headrests 5 and/or by adjusting seat surface 3, arm rests etc.

A tire pressure sensor 20, which detects the actual pressure pₜ of tire 19 and sends an appropriate signal to display 21, is assigned to every tire of vehicle 1, of which only one tire 19 is shown. The driver of the vehicle is thereby able to verify whether the tire pressure is sufficient and/or is uniform in the tires of one axle.

According to the present invention, the signal corresponding to the actual pressure pₜ is also sent to a differentiator 22, which generates a signal corresponding to a pressure change Δp.

Differentiator 22, for example, may take the form of a differential quotient former, or may also feature a subcontractor 23, to which the actual pressure signal pₜ and a pressure signal p_{t-dt} delayed by time-delay element 24 is sent to generate differential signal Δp. The figure shows schematically that the other tires of vehicle 1 are likewise assigned differentiators 22′, 22″. In a comparator 25, differential signal Δp is analyzed to see whether it has a higher value than a threshold value signal Δpₛ This threshold value signal Δpₛ is chosen in such a way that it corresponds to a rapid pressure loss in the tire pressure, which could trigger an uncontrollable vehicle behavior such as a breakaway, skidding or the like. Thus the value of the differential signal Δp will at any rate exceed the threshold value Δpₛ in the event of a tire blowout.

In a given case, an appropriate signal is sent as a parameter signal for the precrash case to triggering control 17, which an also be fed other parameter signals that brings about a triggering, as indicated schematically.

Like other parameter signals, this signal moreover can be sent via a connecting line inside the vehicle, e.g., a network CAN, to a crash evaluation circuit 26 and thus adjust, in addition to other parameters schematically represented by additional input signals, triggering criteria, that is, change the triggering threshold so as to activate triggering control 12 for the crash in case of an accident.

Of course, both triggering controls 12, 17 and crash evaluation circuit 26 may be integrated into a single overall circuit system.

Further, differentiators 22 and comparators 25 for all tires 19 may also be integrated into such an overall circuit system. This means that in a given case pressure sensor 20 merely has to send the already existing actual pressure signal also to the overall circuit system in order to achieve the necessary position adjustment. This means that the occurrence of a sudden pressure loss such as a tire blowout is regarded as a precrash case, which may be, but is not necessarily, followed by an accident (crash).

If a sudden pressure loss such as a tire blowout is detected, the procedure according to the present invention brings the vehicle occupant in a favorable sitting position, in which he is protected from injuries, which may be incurred even if the vehicle driver is still able to catch the vehicle without an accident occurring.

In case the overall circuit system contains a microcomputer, this microcomputer can execute the differentiator and comparator functions and additionally execute the functions adjusting the triggering thresholds.

1-10. (canceled)

11. A method for protecting a vehicle occupant in the occurrence of a potentially dangerous situation, comprising:
continuously monitoring a value of the loss of a tire pressure of at least one tire of the vehicle; and
triggering activation of at least one system that is assigned to a seat of the vehicle occupant and is configured to be reversibly activated, if the value of the loss of the tire pressure of at least one tire exceeds a threshold value, wherein exceeding of the threshold value corresponds to a sudden pressure loss occurring in a tire blowout.

12. The method as recited in claim 11, wherein the system is a belt tensioner configured to be reversibly activated for fixing the vehicle occupant to the seat of the vehicle occupant.

13. The method as recited in claim 1 1, wherein if activation of the system is triggered, an existence of an imminent possibility of an accident is assumed and an appropriate information is transmitted to at least one triggering unit for adjusting a triggering threshold for triggering at least one restraint device.

14. The method as recited in claim 12, wherein if activation of the system is triggered, an existence of an imminent possibility of an accident is assumed and an appropriate information is transmitted to at least one triggering unit for adjusting a triggering threshold for triggering at least one restraint device.

15. The method as recited in claim 13, wherein the appropriate information is fed into a vehicle information network and is made available to a plurality of triggering units for adjusting at least one of parameters and triggering thresholds for triggering a plurality of restraint devices.

16. The method as recited in claim 14, wherein the appropriate information is fed into a vehicle information network and is made available to a plurality of triggering units for adjusting at least one of parameters and triggering thresholds for triggering a plurality of restraint devices.

17. A system for protecting a vehicle occupant in the occurrence of a potentially dangerous situation, comprising:
at least one system that is assigned to a seat of the vehicle occupant and is configured to be reversibly activated;
a pressure sensor for monitoring a pressure of at least one tire;
an analysis unit for analyzing the pressure of the at least one tire to determine whether a value of a loss of the pressure of the at least one tire exceeds a threshold value; and
a triggering control unit for triggering activation of the at least one system that is assigned to the seat of the vehicle occupant and is configured to be reversibly activated, if the value of the loss of the tire pressure of the at least one tire exceeds the threshold value, wherein exceeding of the threshold value corresponds to a sudden pressure loss occurring in a tire blowout.

18. The system as recited in claim 17, wherein the triggering control unit activates a tensioning mechanism of a reversible belt tensioning system.

19. The system as recited in claim 17, further comprising a crash evaluation circuit, wherein a signal indicating the exceeding of the threshold value is sent to the crash evaluation circuit for use as a parameter indicating an existence of imminent possibility of an accident.

20. The system as recited in claim 18, further comprising a crash evaluation circuit, wherein a signal indicating the exceeding of the threshold value is sent to the crash evaluation circuit for use as a parameter indicating an existence of imminent possibility of an accident.

21. The system as recited in claim 17, wherein a signal indicating the exceeding of the threshold value is fed into a vehicle information network.

22. The system as recited in claim 18, wherein a signal indicating the exceeding of the threshold value is fed into a vehicle information network.

23. The system as recited in claim 19, wherein a signal indicating the exceeding of the threshold value is fed into a vehicle information network.
